(19) United States
(12) Patent Application Publication
(10) Pub. No.: US 2019/0325495 A1
(43) Pub. Date: Oct. 24, 2019

(54) SYSTEMS AND METHODS FOR DIRECT E-COMMERCE ORDERING FROM EXTERNAL WEBSITES

(71) Applicant: Christopher Stark, Scottsdale, AZ (US)

(72) Inventor: Christopher Stark, Scottsdale, AZ (US)

(21) Appl. No.: 16/387,451

(22) Filed: Apr. 17, 2019

Related U.S. Application Data
(60) Provisional application No. 62/659,298, filed on Apr. 18, 2018.

(51) Int. Cl. G06Q 30/06

(52) U.S. Cl. CPC G06Q 30/0613; G06Q 30/0641; G06Q 30/0633

(57) ABSTRACT

Systems and methods for direct e-commerce ordering on external websites is disclosed. Consumers may post a comment on the external website to initiate the purchase of an item or service from the corresponding e-commerce system. The system may scrub the comment system of the external website to locate the direct ordering request. The system may transmit the direct ordering request to the corresponding e-commerce system. The e-commerce system may process the direct ordering request to determine the associated consumer that submitted the request, and may process payment and complete the transaction.

### CROSS-REFERENCE TO RELATED APPLICATIONS

This Non-Provisional Patent Application claims priority to U.S. Provisional Patent Application Ser. No. 62/659,298, entitled “SYSTEMS AND METHODS FOR DIRECT E-COMMERCE ORDERING FROM EXTERNAL WEBSITES,” and filed Apr. 18, 2018, which is incorporated herein by reference in its entirety.

### FIELD

The disclosure generally relates to online shopping, and more specifically, to systems and methods for direct e-commerce ordering from external websites.

### BACKGROUND

Consumers may shop online by accessing e-commerce systems and platforms to purchase items (e.g., physical goods, clothes, digital downloads, etc.). Consumers may also desire to purchase items displayed on third-party websites that may not be associated with, or have a relationship with, the e-commerce systems and platforms. For example, consumers may browse social media (e.g., FACEBOOK®, INSTAGRAM®, SNAPCHAT®, etc.), and/or similar third-party websites, to discover items they desire to purchase. Typically, the consumer may need to separately navigate to the associated e-commerce system to locate the item they discovered on the external third-party website, before then completing the purchase using a standard check-out process on the e-commerce system. The third-party website may also display a link that the consumer can access to transfer the consumer to the item's landing page on the e-commerce system, to then allow the consumer to continue to purchase the discovered item from the item's landing page. The purchasing process after discovering an item on the third-party website may take multiple steps, thus requiring additional processing and time spent by the consumer before the purchase can be completed.

Therefore, it would be advantageous to provide a system and method that would allow a consumer to see a product or service on a social media website and purchase it directly from the website. This purchase would be without the need to visit a third party website and would streamline purchasing over social media websites.

### SUMMARY

In various embodiments, systems, methods, and articles of manufacture (collectively, “the system”) for direct e-commerce ordering from external third-party websites are disclosed. The system may enable consumers to purchase items, services, or the like by posting a direct ordering request on the external third-party website. In that respect, instead of needing a consumer to access the e-commerce system directly to purchase the item or service, the system allows the consumer to input a direct ordering request directly into the external website to trigger a purchase of that item or service from the corresponding e-commerce system.

In various embodiments, the system enables a customer to visit a social media website and purchase items without leaving the social media website. This system prevents the need to visit a third party website directly and navigate away from the social media website which speeds up the process of online ordering for customers and increases sales for merchants.

In various embodiments, the system may comprise a processor and a tangible non-transitory memory configured to communicate with the processor. The tangible, non-transitory memory may have instructions stored thereon that, in response to execution by the processor, cause the processor to perform operations comprising: scrubbing, by the processor, a comment system of an interactive platform; locating, by the processor, a direct ordering request corresponding to an e-commerce system and a user identifier; and transmitting, by the processor, the direct ordering request to the e-commerce system, wherein in response to receiving the direct ordering request the e-commerce system is configured to at least one of complete the direct ordering request or transmit a direct ordering response.

In various embodiments, the interactive platform may comprise a social media platform, a blog, an opinion source, and/or a fashion source. The e-commerce system may comprise an e-commerce retailer, an e-commerce specialty retailer, and/or an e-commerce platform. The direct ordering request may comprise a direct ordering identifier and/or an item identifier. The direct ordering identifier may comprise a dollar sign (“$”), an exclamation point (“!”), an at sign (“@”), a pound sign (“#”), a percent sign (“%”), and/or an asterisk (“*”). The item identifier may comprise an item name, an item SKU, a unique direct ordering number, and/or an item property. The direct ordering request may comprise an influencer ID. In response to the system completing the direct ordering request, the e-commerce system is configured to remit an influencer payment to a user associated with the influencer ID, wherein the influencer payment is based on the direct ordering request.

In various embodiments, a method is disclosed. The method may comprise the steps of scrubbing a comment system of an interactive platform, wherein the comment system is scrubbed to determine whether a comment in the comment system includes a direct ordering identifier; locating a direct ordering request comprising the direct ordering identifier, wherein the direct ordering request is associated with a user identifier; determining an e-commerce system associated with the direct ordering request; and transmitting the direct ordering request to the e-commerce system, wherein in response to receiving the direct ordering request the e-commerce system at least one of completes the direct ordering request or transmits a direct ordering response to a user associated with the user identifier.

In various embodiments, the method may also comprise the step of receiving an e-commerce direct ordering registration request from the e-commerce system, wherein the e-commerce direct ordering registration request comprises an interactive platform URL associated with the interactive platform and a predetermined scrubbing interval. The direct ordering request may comprise the interactive platform URL, and wherein the determining the e-commerce system associated with the direct ordering request comprises determining the e-commerce system that transmitted the e-commerce direct ordering registration request comprising the interactive platform URL. The step of scrubbing the comment system of the interactive platform may be based on the predetermined scrubbing interval. In response to receiving the direct ordering request, the e-commerce system may determine an item and/or a service associated with the direct ordering request. The direct ordering request may comprise an item identifier, and wherein the item identifier comprises an item name, an item SKU, a unique direct ordering number, and/or an item property. The e-commerce system may determine the item associated with the direct ordering request based on the item identifier.

In various embodiments, a method is disclosed. The method may comprise the steps of scrubbing, by a direct ordering system, a comment system of an interactive platform; locating, by the direct ordering system, a direct ordering request corresponding to an e-commerce system and a user identifier; and transmitting, by the direct ordering system, the direct ordering request to the e-commerce system, wherein in response to receiving the direct ordering request the e-commerce system determines an item associated with the direct ordering request, and wherein in response to determining the item, the e-commerce system transmits a direct ordering response to a user device associated with the user identifier.

In various embodiments, in response to determining the item the e-commerce system may determine whether the item is available for purchase. In response to the item being available for purchase, the direct ordering response may comprise at least one of data indicating a successful purchase or shipping information. In response to the item being available for purchase the e-commerce system completes the direct ordering request. The e-commerce system may complete the direct ordering request by submitting a payment request and/or initiating a delivery of the item.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for direct e-commerce ordering from external websites, in accordance with various embodiments;

FIG. 2 is a block diagram illustrating various sub-system components of a direct ordering system for an exemplary system for direct e-commerce ordering from external websites, in accordance with various embodiments;

FIG. 3 illustrates a process flow for a method of registration in a direct ordering system, in accordance with various embodiments; and

FIG. 4 illustrates a process flow for a method of direct e-commerce ordering from external websites, in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and/or functional changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Consumers may desire to purchase items displayed on third-party websites that may not be associated with the corresponding e-commerce system from which the item originates. For example, a user browsing social media may locate an item (e.g., clothing, etc.) or service and desire to purchase that item or service from the associated e-commerce system. The present disclosure provides a system, method, and article of manufacture (collectively, “the system”) for direct e-commerce ordering from external websites. In that respect, instead of needing a consumer to access the e-commerce system directly to purchase an item or service, the system allows the consumer to input a direct ordering request directly into the external website to trigger a purchase of that item or service from the corresponding e-commerce system, as discussed further herein. The direct ordering request may be input as a comment into the external website, and may comprise any suitable purchasing identifier (e.g., to identify the comment as being a direct ordering request).

In various embodiments, the direct ordering request may comprise a direct ordering identifier and an item identifier. The direct ordering identifier may comprise a character, number, symbol, or the like indicating that the posted comment is a direct ordering request. For example, the direct ordering identifier may comprise the first character in the posted comment and may comprise a dollar sign (“$”), an exclamation point (“!”), an at sign (“@”), a pound sign or hashtag (“#”), a percent sign (“%”), an asterisk (“*”), and/or any other suitable character (e.g., “$directorderrequest”). The item identifier may comprise characters, numbers, symbols, or the like indicating the item or service that is desired to be purchased through the direct ordering request. For example, the item identifier may comprise an item name (e.g., “$itemname”), an item stock keeping unit (SKU) (e.g., “$9678123789”), a unique direct ordering number (e.g., “$1234”), and/or an item property such as color, size, or the like (e.g., “$itemname blue medium”). In various embodiments, the direct ordering request may also comprise data regarding the user who input the direct ordering request, such as, for example, an interactive platform user identifier. The direct ordering request may also comprise data corresponding to the referring source, such as, for example, the interactive platform originating the direct ordering request, an influencer ID (e.g., a product influencer paid to promote products may host a unique web page on the interactive platform), or the like.

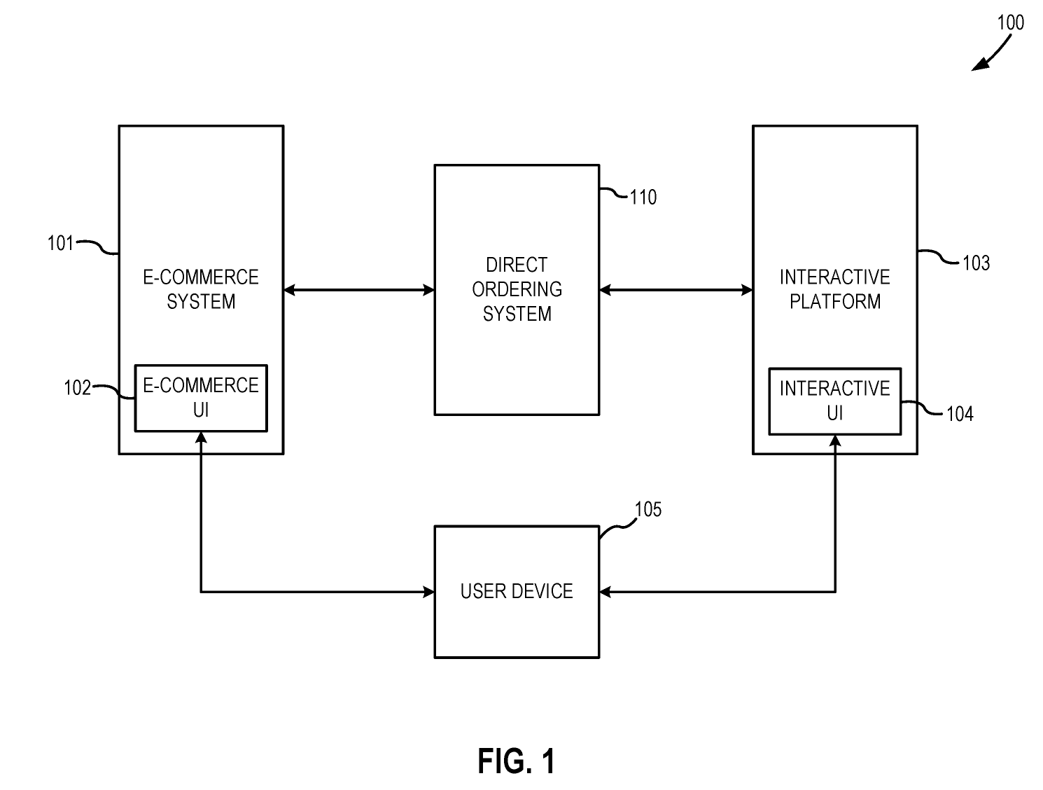

The system further improves the functioning of the computer or server (e.g., user device 105, with brief reference to FIG. 1). For example, by the consumer simply inputting a direct ordering request instead of manually navigating to the e-commerce system and completing the purchase process, the user performs less computer functions and provides less input, which saves on data storage and memory thus speeding processing in the computer or server. Wherein the computer is a mobile device or similar battery-powered computer, by reducing the amount of consumer input needed to complete a purchase from a third-party website the system may also save battery life in the mobile device or battery-powered device. In various embodiments, the system may also improve the security of data being transferred. For example, by requiring less input from the user, less data will be transferred over networks that may be unsecure or unknown. In a practical application wherein the system is used to complete a transaction via the direct ordering request, the user may input less sensitive information (e.g., payment information, shipping information, etc.) over unsecure channels, thus improving the security of sensitive data in comparison to typical systems. Similarly, the system may reduce bandwidth usage by requiring less input from the user in comparison to typical systems.

In various embodiments, and with reference to FIG. 1, a system 100 for direct e-commerce ordering from external websites is disclosed. System 100 may comprise various systems, platforms, engines, modules, databases, and components with different roles. The various systems, platforms, engines, modules, databases and components described herein may be in direct logical communication with each other via a bus, network, and/or through any other suitable logical interconnection permitting communication amongst the various systems, platforms, engines, modules, databases and components, or may be individually connected as described further herein. More specifically, and in accordance with various embodiments, system 100 may comprise one or more of an e-commerce system 101, an interactive platform 103, a user device 105, and/or a direct ordering system 110.

In various embodiments, a consumer may interface with user device 105 to access and interact with e-commerce system 101 and interactive platform 103. User device 105 may include any device which communicates, in any manner discussed herein, with e-commerce system 101 and/or interactive platform 103, via any network or protocol discussed herein. For example, user device 105 may comprise a computing device such as a server, laptop, notebook, hand held computer, personal digital assistant, cellular phone, smart phone (e.g., IPHONE®, BLACKBERRY®, ANDROID®, etc.), tablet, wearable (e.g., smart watches, smart glasses, smart rings, etc.), internet of things (IoT) device, smart speaker, or any other similar device. User device 105 may comprise software configured to aid user device 105 in interacting with e-commerce system 101 and/or interactive platform 103, such as, for example, an internet browser (e.g., MICROSOFT INTERNET EXPLORER®, GOOGLE CHROME®, etc.), mobile application, or the like. Practitioners will appreciate that user device 105 may or may not be in direct electronic communication with e-commerce system 101 and/or interactive platform 103. For example, user device 105 may access the services of e-commerce system 101 and/or interactive platform 103 through another server, which may have a direct or indirect connection to an internet server. Practitioners will further recognize that user device 105 may present interfaces associated with a software application or module that are provided to user device 105 via application graphical user interfaces (GUIs) or other interfaces and are not necessarily associated with or dependent upon internet browsers or internet specific protocols.

In various embodiments, e-commerce system 101 may be in electronic communication with user device 105 and/or direct ordering system 110. E-commerce system 101 may be configured to provide various shopping capabilities to consumers, via user device 105. For example, e-commerce system 101 may be configured to allow consumers to register for a user e-commerce account, browse for items and/or services, purchase items and/or services, and the like. In that respect, e-commerce system 101 may comprise any system configured to provide online shopping capabilities, such as, for example, systems provided by an e-commerce retailer (e.g., ALIBABA®, AMAZON®, TARGET®, WALMART®, etc.); an e-commerce specialty retailer (e.g., NORDSTROM®, J.CREW®, WILLIAMS SONOMA®, etc.); an e-commerce platform (e.g., BIGCOMMERCE®, SHOPIFY®, SQUARESPACE®, WOOCOMMERCE®, etc.); and/or any other suitable e-commerce system.

E-commerce system 101 may comprise one or more network environments, servers, computer-based systems, processors, databases, and/or the like configured to provide the shopping capabilities. E-commerce system 101 may comprise at least one computing device in the form of a computer or processor, or a set of computers/processors, although other types of computing units or systems may be used such as, for example, a server, web server, pooled servers, or the like. E-commerce system 101 may also include software, such as services, APIs, and the like, configured to perform various operations discussed herein. E-commerce system 101 may comprise any suitable number of back-end systems to provide item inventory, transaction processing, item shipment and/or delivery, and/or the like. For example, e-commerce system 101 may provide an e-commerce user interface (“UI”) 102 accessible via user device 105. E-commerce UI 102 may be accessible via a web browser (e.g., GOOGLE CHROME®, MICROSOFT INTERNET EXPLORER®, etc.), a mobile application (e.g., downloaded via APPLE® APP STORE®, GOOGLE PLAY®, etc.), or the like. In that regard, a consumer, via user device 105, may access e-commerce UI 102 of e-commerce system 101 to register for a user e-commerce account, browse for items (physical or digital) and/or services, purchase items and/or services, or the like.

In various embodiments, interactive platform 103 may be in electronic communication with user device 105 and/or direct ordering system 110. Interactive platform 103 may comprise any system, platform, or the like that allows users to post comments on articles, posts, images, videos, or the like. For example, interactive platform 103 may comprise a comment system enabled by social media (e.g., FACEBOOK®, INSTAGRAM®, PINTEREST®, QZONE®, SNAPCHAT®, TWITTER®, VKONTAKTE (VK), YOUTUBE®, etc.); a blog (e.g., a style/fashion blog, a news blog, a cooking blog, etc.); a news, multimedia, or opinion source (e.g., THE NEW YORK TIMES®, THE WALL STREET JOURNAL®, etc.); a fashion or style source (e.g., GQ®, ESQUIRE®, VOGUE®, VANITY FAIR®, etc.); and/or any other suitable system, platform, or the like that allows users to post comments.

Interactive platform 103 may comprise one or more network environments, servers, computer-based systems, processors, databases, and/or the like configured to allow users to register for an account; browse articles, posts, images, videos, or the like; post comments on the articles, posts, images, videos, or the like; and/or post original user content. Interactive platform 103 may comprise at least one computing device in the form of a computer or processor, or a set of computers/processors, although other types of computing units or systems may be used such as, for example, a server, web server, pooled servers, or the like. Interactive platform 103 may also include software, such as services, APIs, and the like, configured to perform various operations discussed herein. For example, interactive platform 103 may provide an interactive user interface (“UI”) 104 accessible via user device 105. Interactive UI 104 may be accessible via a web browser (e.g., GOOGLE CHROME®, MICROSOFT INTERNET EXPLORER®, etc.), a mobile application (e.g., downloaded via APPLE® APP STORE®, GOOGLE PLAY®, etc.), or the like. In that regard, a consumer, via user device 105, may access interactive UI 104 of interactive platform 103 to register for an account; browse articles, posts, images, videos, or the like; post comments on the articles, posts, images, videos, or the like; post original user content; and/or the like.

In various embodiments, direct ordering system 110 may be in electronic communication with e-commerce system 101 and/or interactive platform 103. Direct ordering system 110 may be configured to interact with e-commerce system 101 to receive one or more direct ordering registration requests, as discussed further herein. Direct ordering system 110 may be configured to interact with interactive platform 103 to locate and process one or more direct ordering requests, as discussed further herein, and transfer the direct ordering requests to e-commerce system 101. Direct ordering system 110 may comprise one or more network environments, servers, computer-based systems, processors, databases, and/or the like. Direct ordering system 110 may comprise at least one computing device in the form of a computer or processor, or a set of computers/processors, although other types of computing units or systems may be used such as, for example, a server, web server, pooled servers, or the like. Direct ordering system 110 may also include software, such as services, APIs, and the like, configured to perform various operations discussed herein. In various embodiments, direct ordering system 110 may be computer based, and may comprise a processor, a tangible non-transitory computer-readable memory, and/or a network interface, along with other suitable system software and hardware components. Instructions stored on the tangible non-transitory memory may allow direct ordering system 110 to perform various functions, as described herein.

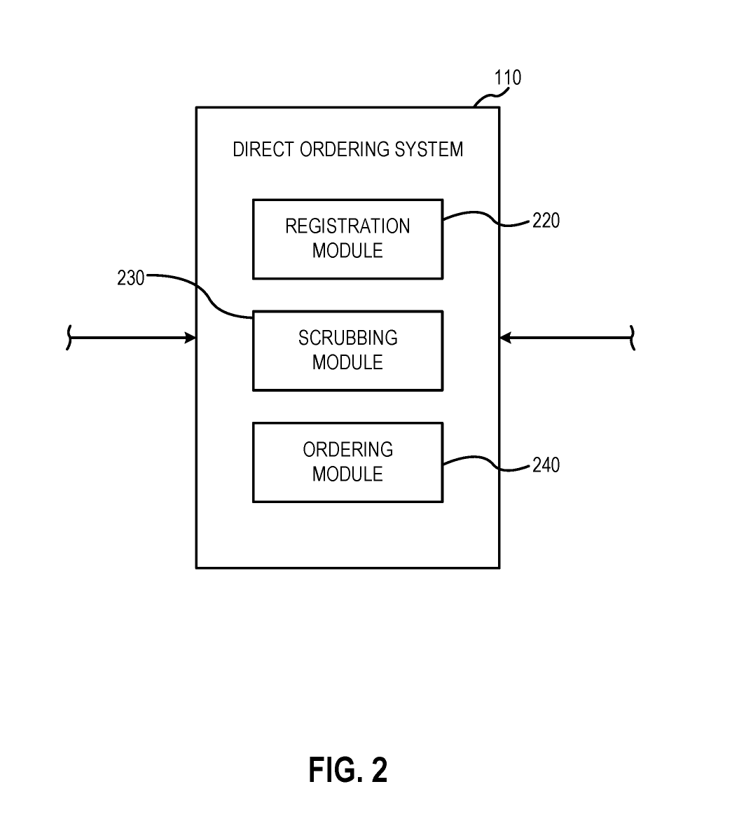

In various embodiments, direct ordering system 110 may include a plurality of software modules that are stored in a computer-readable medium as a plurality of computer-executable instructions. Alternatively, or additionally, the modules may be implemented in hardware (such as one or more circuits) and/or firmware. In various embodiments, and with reference to FIG. 2, direct ordering system 110 may include, for example, a registration module 220, a scrubbing module 230, and/or an ordering module 240.

In various embodiments, registration module 220 may be configured to receive e-commerce direct ordering registration requests from e-commerce system 101. Each e-commerce direct ordering registration request may comprise one or more interactive platforms 103 and a predetermined scrubbing interval. The list of interactive platforms 103 may comprise identifiers (e.g., uniform resource locator (URL), IP address, etc.) of each interactive platform 103 that e-commerce system 101 desires to enable direct ordering from. The predetermined scrubbing interval may comprise data indicating the frequency (e.g., every five minutes, every two hours, etc.) that each interactive platform 103 should be scrubbed to locate direct ordering requests. In that respect, the e-commerce direct ordering registration request may comprise one predetermined scrubbing interval to control scrubbing for all listed interactive platforms 103, or may comprise individual predetermined scrubbing intervals for each listed interactive platform 103. Registration module 220 may be configured to store internal data in direct ordering system 110 comprising each registered e-commerce system 101 and the corresponding associated interactive platforms 103.

In various embodiments, scrubbing module 230 may be configured to scrub interactive platform 103 to locate one or more direct ordering requests. Scrubbing module 230 may be configured to access one or more interactive platforms 103 associated with each e-commerce system 101 registration stored in internal data. Scrubbing module 230 may be configured to access each interactive platform 103 based on the predetermined scrubbing interval. For example, scrubbing module 230 may be configured to scrub the comment system of interactive platform 103 by parsing comments posted on the comment system. Scrubbing module 230 may be configured to scrub the comment system based on a date range (e.g., only comments after a specified time stamp), or according to any other limitation. Scrubbing module 230 may scrub the comment system to locate one or more direct ordering requests. For example, scrubbing module 230 may scrub the comment system based on the direct ordering identifier to locate one or more direct ordering requests (e.g., to locate posted comments beginning with the direct ordering identifier, such as the dollar sign (“$”)). In response to locating a comment comprising a direct ordering identifier (e.g., a direct ordering request), scrubbing module 230 may capture the comment and transmit the comment to ordering module 240.

In various embodiments, ordering module 240 may be configured to analyze the direct ordering requests to determine the e-commerce system 101 to transmit the direct ordering request to. For example, ordering module 240 may query the internal data to locate the registered e-commerce system. Ordering module 240 may be configured to transmit the direct ordering request to the associated e-commerce system 101 to complete the transaction.

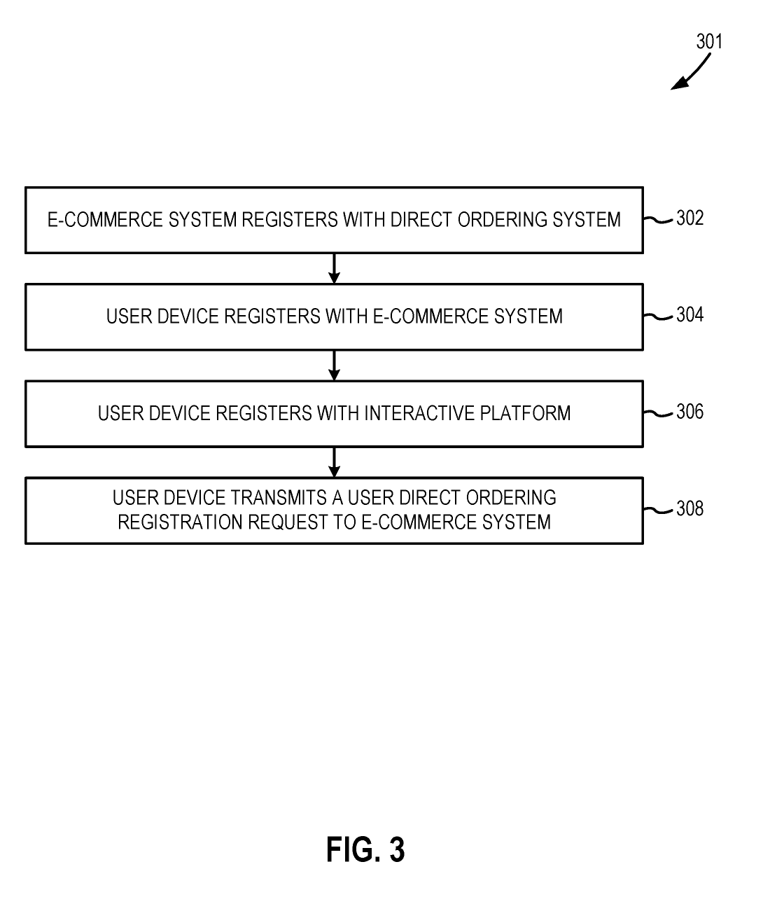

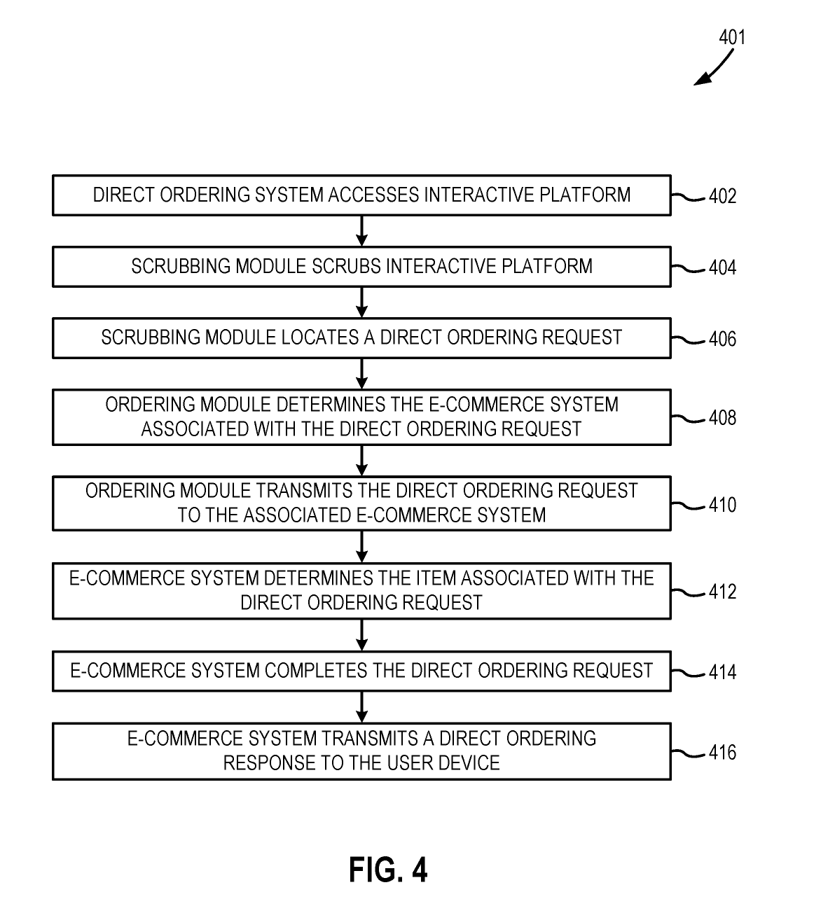

Referring now to FIGS. 3 and 4, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and elements depicted in FIGS. 3 and 4, but also to the various system components as described above with reference to FIGS. 1 and 2.

In various embodiments, and with specific reference to FIG. 3, a method 301 for registration with a direct ordering system is disclosed. Method 301 may comprise e-commerce system 101 registering with direct ordering system 110 (step 302). For example, e-commerce system 101 may transmit an e-commerce direct ordering registration request to direct ordering system 110, via registration module 220. The e-commerce direct ordering registration request may comprise one or more interactive platforms 103 and a predetermined scrubbing interval. The list of interactive platforms 103 may comprise identifiers (e.g., uniform resource locator (URL), etc.) of each interactive platform 103 that e-commerce system 101 desires to enable direct ordering from. The predetermined scrubbing interval may comprise data indicating the frequency (e.g., every five minutes, every two hours, etc.) that each interactive platform 103 should be scrubbed to locate direct ordering requests. In that respect, the e-commerce direct ordering registration request may comprise one predetermined scrubbing interval to control scrubbing for all listed interactive platforms 103, or may comprise individual predetermined scrubbing intervals for each listed interactive platform 103.

In various embodiments, method 301 may comprise user device 105 registering with e-commerce system 101 (step 304). Users may register with e-commerce system 101 by setting up an e-commerce account with e-commerce system 101, via e-commerce UI 102. For example, users may register by creating an e-commerce user identifier and password and by inputting identifying data such as a shipping address, billing information, billing address, and the like. Method 301 may comprise user device 105 registering with interactive platform 103 (step 306). Users may register with interactive platform 103, via interactive UI 104, to enable the posting of comments on articles, posts, images, videos, or the like. For example, users may register with interactive platform 103 by creating an interactive platform user identifier and password, and/or through any other registration process.

In various embodiments, method 301 may comprise user device 105 transmitting a user direct ordering registration request to e-commerce system 101 (step 308). For example, a user may input the e-commerce user identifier and password, via user device 105, to access their e-commerce account associated with e-commerce system 101. The user may transmit the user direct ordering registration request by selecting one or more interactive platforms 103 that e-commerce system 101 has enabled for direct ordering. For example, and in accordance with various embodiments, the user may select one or more interactive platforms 103 and input an associated interactive platform user identifier (e.g., as registered in step 306). In various embodiments, the user may also select one or more direct ordering settings, such as, for example, a default shipping address, billing information, and the like.

In various embodiments, and with specific reference to FIG. 4, a method 401 for direct e-commerce ordering from external websites is disclosed. Although method 401 discusses a method of direct e-commerce ordering wherein an item is purchased, it should be understood that method 401 may apply to the direct ordering of any suitable or desired physical item, digital item, service, or the like. For example, phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

Method 401 may comprise direct ordering system 110 accessing interactive platform 103 (step 402). Direct ordering system 110, via scrubbing module 230, may be configured to access one or more interactive platforms 103 based on the registration completed in step 302, with brief reference to FIG. 3. Direct ordering system 110, via scrubbing module 230 may be configured to access the interactive platform 103 based on the predetermined scrubbing interval.

In various embodiments, method 401 may comprise direct ordering system 110, via scrubbing module 230, scrubbing interactive platform 103 (step 404). Scrubbing module 230 may be configured to scrub the comment system of interactive platform 103 by parsing comments posted on the comment system of interactive platform 103. For example, scrubbing module 230 may parse the posted comments to locate one or more comments comprising the direct ordering identifier. Scrubbing module 230 may be configured to scrub the comment system based on a date range (e.g., only comments posted after a specified time stamp, within a designated time frame, etc.), or according to any other limitation. For example, scrubbing module 230 may be configured to scrub posted comments in the comment system based on the previous scrub (e.g., comments posted since the last time scrubbing module 230 scrubbed the comment system). Method 401 may comprise direct ordering system 110, via scrubbing module 230, locating a direct ordering request (step 406). Scrubbing module 230 may scrub the comment system to locate one or more direct ordering requests. For example, scrubbing module 230 may scrub the comment system based on the direct ordering identifier to locate one or more direct ordering requests.

Method 401 may comprise direct ordering system 110, via ordering module 240, determining the e-commerce system 101 associated with the direct ordering request (step 408). For example, direct ordering system 110 may comprise an internal database, table, or list comprising e-commerce systems 101 corresponding to each interactive platform 103. For example, and in accordance with various embodiments, direct ordering system 110 may comprise an internal database of interactive platform URLs registered for each e-commerce system 101. The interactive platform URLs may comprise subdomains of one or more parent interactive platform URLs. In various embodiments, a subdomain may comprise an interactive platform URL that is unique to an associated e-commerce system. In that regard, determining the e-commerce system 101 associated with the direct ordering request may comprise parsing metadata, data, tags, or the like associated with the direct ordering request to determine the interactive platform URL, and marching the interactive platform URL with internal data to determine the e-commerce system 101.

Method 401 may comprise direct ordering system 110, via ordering module 240, transmitting the direct ordering request to the associated e-commerce system 101 (step 410). In various embodiments, the direct ordering request may also comprise the interactive platform user identifier, the interactive platform 103 from which the direct ordering request was located, an influencer ID, or the like.

In various embodiments, method 401 may comprise e-commerce system 101 determining the item associated with the direct ordering request (step 412). For example, e-commerce system 101 may determine the item based on the item identifier. For example, in response to the item identifier comprise an item SKU (stock keeping unit), e-commerce system 101 may identify the item based on an internal list of item SKU's. As a further example, in response to the item identifier comprising a unique direct ordering number, e-commerce system 101 may identify the item by comparing the item identifier against an internal listing of unique direct ordering numbers. In response to the item identifier comprising an item property (e.g., size, color, etc.), e-commerce system 101 may further determine the item associated with the defined item properties. In various embodiments, e-commerce system 101 may further determine the e-commerce user identifier associated with the direct ordering request. For example, e-commerce system 101 may compare the interactive platform user identifier associated with the direct ordering request against stored e-commerce user identifiers (e.g., as registered in step 304, with brief reference to FIG. 3).

Method 401 may comprise e-commerce system 101 completing the direct ordering request (step 414). For example, e-commerce system 101 may query internal databases to determine whether the item specified in the direct ordering request is in stock and otherwise available for purchase. In response to determining that the item is available for purchase, e-commerce system 101 may continue with standard transaction protocols, such as submitting a payment request based on the billing information, initiating shipment and/or delivery of the purchased item, and/the like. In various embodiments, wherein the direct ordering request comprises an influencer ID, completing the direct ordering request may also comprise e-commerce system 101 remitting an influencer payment to a user (e.g., the influencer) associated with the influencer ID. For example, the user may have an agreement with e-commerce system 101 to earn a percentage, fixed payment, or the like of direct ordering requests completed from an interactive platform associated with the user. In various embodiments, the influencer payment may be remitted in batch, based on a minimum payment threshold, and/or through any other suitable payment agreement.

In various embodiments, method 401 may comprise e-commerce system 101 transmitting a direct ordering response to user device 105 (step 416). For example, in response to determining that the item specified in the direct ordering request is not available, the direct ordering response may comprise data indicating that the item is out of stock, the wait time for shipment, or the like. In response to determining that the item specified in the direct ordering request is available, and in response to completing the purchase, the direct ordering response may comprise data indicating a successful purchase (e.g., purchase price, taxes, total purchase price, etc.), shipping information (e.g., tracking information, shipping carrier, estimated arrival, etc.), and the like. E-commerce system 101 may transmit the direct ordering response using any suitable messaging platform, such as email systems, wireless communications systems, mobile communications systems, multimedia messaging service (“MMS”) systems, short messaging service (“SMS”) systems, and the like. E-commerce system 101 may also transmit the direct ordering response by displaying the direct ordering response, via a GUI, webpage, or the like, for viewing by the user on user device 105.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “transmit” may include sending at least a portion of electronic data from one system component to another. Additionally, as used herein, “data,” “information,” or the like may include encompassing information such as commands, queries, files, messages, data for storage, and the like in digital or any other form.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the system components may be in electronic communication via a network. As used herein, the term “network” may further include any cloud, cloud computing system, or electronic communications system or method that incorporates hardware and/or software components. Communication amongst the nodes may be accomplished through any suitable communication channels such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, DSL, or various wireless communication methods. It is noted that the network may be implemented as other types of networks, such as an interactive television (ITV) network. Moreover, the system contemplates the use, sale or distribution of any goods, services or information over any network having similar functionality described herein.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between data elements. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input, and/or any other method known in the art.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. As those skilled in the art will appreciate, a user computer may include an operating system (e.g., WINDOWS®, UNIX®, LINUX®, SOLARIS®, MACOS®, etc.) as well as various conventional support software and drivers typically associated with computers.

The present system, or any part(s) or function(s) thereof, may be implemented using hardware, software, or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include GROUPON®, LIVINGSOCIAL®, and the like. Moreover, examples of mobile device communications include texting, email, and mobile applications for smartphones.

Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, components, modules, and/or engines of system 100, or one or more subcomponents of system 100, may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

In various embodiments, the system may implement middleware to provide software applications and services, and/or to bridge software components in the computer-based system, such as the operating system, database, applications, and the like. Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQTM (formerly MQSeries) by IBM®, Inc. (Armonk, NY) is an example of a commercially available middleware product. An Enterprise Service Bus (“ESB”) application is another example of middleware.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In various embodiments, one or more servers discussed herein may include application servers (e.g. WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems).

Users, systems, computer-based systems or the like may communicate with the server via a web client. The web client includes any device or software which communicates via any network such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any databases discussed herein may include relational, hierarchical, graphical, blockchain, object-oriented structure, and/or any other database configurations. In various embodiments, any database may also include a no-SQL database, a key-value database, an in-memory database, a GPU database, and/or the like. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers, or other components of the system may consist of any combination thereof at a single location or at multiple locations, wherein each database, system, device, server, and/or other component includes any of various suitable security features, such as firewalls, access codes, encryption, decryption, compression, decompression, and/or the like.

Encryption of data in system 100, including in one or more databases, may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic-curve cryptography (e.g., ECC, ECDH, ECDSA, etc.), and/or other post-quantum cryptography algorithms under development.

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, any other application server components or may reside within another computing device or may take the form of a standalone hardware component.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art, and are covered in many standard texts.

In various embodiments, the software elements of the system may also be implemented using a JAVASCRIPT® run-time environment configured to execute JAVASCRIPT® code outside of a web browser. For example, the software elements of the system may be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, mechanical, electrical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for direct e-commerce ordering, comprising:
a processor; and
a tangible, non-transitory memory configured to communicate with the processor, the tangible, non-transitory memory having instructions stored thereon that, in response to execution by the processor, cause the processor to perform operations comprising:
scrubbing, by the processor, a comment system of an interactive platform;
locating, by the processor, a direct ordering request corresponding to an e-commerce system and a user identifier; and
transmitting, by the processor, the direct ordering request to the e-commerce system, wherein in response to receiving the direct ordering request the e-commerce system is configured to at least one of complete the direct ordering request or transmit a direct ordering response.

2. The system of claim 1, wherein the interactive platform comprises a social media platform, a blog, an opinion source, or a fashion source.

3. The system of claim 1, wherein the e-commerce system comprises an e-commerce retailer, an e-commerce specialty retailer, or an e-commerce platform.

4. The system of claim 1, wherein the direct ordering request comprises a direct ordering identifier and an item identifier.

5. The system of claim 4, wherein the direct ordering identifier comprises at least one of a dollar sign (“$”), an exclamation point (“!”), an at sign (“@”), a pound sign (“#”), a percent sign (“%”), or an asterisk (“*”).

6. The system of claim 4, wherein the item identifier comprises at least one of an item name, an item SKU, a unique direct ordering number, or an item property.

7. The system of claim 1, wherein the direct ordering request comprises an influencer ID.

8. The system of claim 7, wherein in response to completing the direct ordering request the e-commerce system is configured to remit an influencer payment to a user associated with the influencer ID, wherein the influencer payment is based on the direct ordering request.

9. A method comprising:
scrubbing, by a computer-based system, a comment system of an interactive platform, wherein the comment system is scrubbed to determine whether a comment in the comment system includes a direct ordering identifier;
locating, by the computer-based system, a direct ordering request comprising the direct ordering identifier, wherein the direct ordering request is associated with a user identifier;
determining, by the computer-based system, an e-commerce system associated with the direct ordering request; and
transmitting, by the computer-based system, the direct ordering request to the e-commerce system, wherein in response to receiving the direct ordering request the e-commerce system at least one of completes the direct ordering request or transmits a direct ordering response to a user associated with the user identifier.

10. The method of claim 9, further comprising receiving, by the computer-based system, an e-commerce direct ordering registration request from the e-commerce system, wherein the e-commerce direct ordering registration request comprises an interactive platform URL associated with the interactive platform and a predetermined scrubbing interval.

11. The method of claim 10, wherein the direct ordering request comprises the interactive platform URL, and wherein the determining the e-commerce system associated with the direct ordering request comprises determining the e-commerce system that transmitted the e-commerce direct ordering registration request comprising the interactive platform URL.

12. The method of claim 10, wherein the scrubbing the comment system of the interactive platform is based on the predetermined scrubbing interval.

13. The method of claim 9, wherein in response to receiving the direct ordering request, the e-commerce system determines at least one of an item or a service associated with the direct ordering request.

14. The method of claim 13, wherein the direct ordering request comprises an item identifier, and wherein the item identifier comprises at least one of an item name, an item SKU, a unique direct ordering number, or an item property.

15. The method of claim 14, wherein the e-commerce system determines the item associated with the direct ordering request based on the item identifier.

16. A method comprising:
scrubbing, by a direct ordering system, a comment system of an interactive platform;
locating, by the direct ordering system, a direct ordering request corresponding to an e-commerce system and a user identifier; and
transmitting, by the direct ordering system, the direct ordering request to the e-commerce system,
wherein in response to receiving the direct ordering request the e-commerce system determines an item associated with the direct ordering request, and
wherein in response to determining the item, the e-commerce system transmits a direct ordering response to a user device associated with the user identifier.

17. The method of claim 16, wherein in response to determining the item, the e-commerce system determines whether the item is available for purchase.

18. The method of claim 17, wherein in response to the item being available for purchase, the direct ordering response comprises at least one of data indicating a successful purchase or shipping information.

19. The method of claim 17, wherein in response to the item being available for purchase the e-commerce system completes the direct ordering request.

20. The method of claim 19, wherein the e-commerce system completes the direct ordering request by at least one of submitting a payment request or initiating a delivery of the item.
